(19) United States
(12) Patent Application Publication
(10) Pub. No.: US 2011/0150225 A1
(43) Pub. Date: Jun. 23, 2011

(54) ENCRYPTION DEVICES FOR BLOCK HAVING DOUBLE BLOCK LENGTH, DECRYPTION DEVICES, ENCRYPTION METHOD, DECRYPTION METHOD, AND PROGRAMS THEREOF

(76) Inventor: Kazuhiko Minematsu, Tokyo (JP)

(21) Appl. No.: 13/060,580

(22) PCT Filed: May 22, 2009
(86) PCT No.: PCT/JP2009/059437

§ 371 Date: Feb. 24, 2011

(30) Foreign Application Priority Data
Aug. 29, 2008 (JP) 2008-221631

(51) Int. Cl. H04L 9/00

(52) U.S. Cl. 380/277

(57) ABSTRACT

An encryption device for a block having double block length permutates a plaintext of 2 n bits based on a universal hash function so as to generate first and second intermediate variables of n bits each, encrypts the first intermediate variable with a tweak that is a result in which the second intermediate variable is shortened to m bits using an encryption function for m-bit tweak n-bit block cipher so as to generate a third intermediate variable of n bits, encrypts the second intermediate variable with a tweak that is a result in which the third intermediate variable is shortened to m bits using the encryption function so as to generate a fourth intermediate variable of n bits, concatenates the third and fourth intermediate variables and inversely mingles the concatenated result based on a universal hash function so as to generate a ciphertext of 2 n bits.

### TECHNICAL FIELD

The present invention relates to an operation mode of a block cipher, in particular, to encryption devices for a block having a double block length using an n-bit block cipher that is versatile and highly safe, decryption devices, an encryption method, a decryption method, and programs thereof.

### BACKGROUND ART

A block cipher is a set of permutations uniquely defined by a key, while an input to the permutations is equivalent to a plaintext and an output thereto is equivalent to a ciphertext. The lengths of plaintexts and ciphertexts are referred to as block sizes. A block cipher having an n-bit block size is generally referred to as an n-bit block cipher. As a technique relating to block encryption/decryption, “Block encryption method and decryption method” disclosed in Patent Document 1 is known.

In the case in which a block cipher having a 2 n-bit block size is constructed, a method that repeats a permutation of 2 n bits using a process called a round function having n-bit input/output is known. For example, DES (Data Encryption Standard) has a block size of 64 bits and is constructed by repeating a permutation called the Feistel type permutation using a process called a round function having a 32-bit input/output length. In a practical block cipher such as DES, since the process of the round function is relatively simple and randomization of the output itself of the round function is low (it can be easily distinguished as a random number), the Feistel type permutation needs to be repeated a sufficient number of times so as to improve randomization of the entire 64 bits. In the case of DES, the permutation is repeated 16 times.

On the other hand, there is an approach that uses the round function having n-bit input/output. This approach has the advantage of high safeness even if a permutation of 2 n bits using the round function is repeated a small number of times. For example, Luby and Rackoff proved that if the output of the round function has so high a randomization that it is not effectively distinguishable from a real random number, by repeating the Feistel type permutation three to four times, a 2 n-bit block cipher that assures computational safeness can be obtained.

Since it is thought that a well-considered exiting n-bit block cipher has a computationally high randomization, a 128-bit block cipher using DES as the round function and a 256-bit block cipher using AES (Advanced Encryption Standard) that is a 128-bit block cipher as the round function can be constructed on the basis of the result of Luby and Rackoff.

Since the above-described block ciphers realize a 2 n-bit block size using the existing block cipher having n-bit block size as a component, they are called “block ciphers having double block length.”

It can be contemplated that block ciphers having double block length are applied to encryption for storage such as hard disks. In encryption for ordinary storage, it is not practical to use a status variable such as a counter from the viewpoint of allocation and safeness of a storage region that maintains the status variable and also since the system requires that the length of a plaintext be equal to that of a ciphertext, forgery cannot be prevented when a message authentication code is used together (when used together with a message authentication code, the ciphertext becomes longer than the plaintext).

To construct block ciphers having double block length, although various methods have been proposed such as a method that repeats the Feistel type permutation four times as disclosed in Non-Patent Document 1 (refer to FIG. 13, FIG. 14), in most cases, however, including this method, the safety assurance is limited to the case that the number of times of encryption, q, processed with one key is much smaller than 2 n/2 (this relationship is denoted by q<<2 n/2). 2 n/2 is called “the birthday bound,” whereas an attack using the result of encryption that repeated the number of times equivalent to that of the birthday bound is generally called the birthday attack. Since such an attack threatens a 64-bit block cipher and would be considered as a future risk for a 128-bit block cipher, countermeasures against such an attack are necessary.

For example, it is known that a construction of which the Feistel type permutation is repeated four times is subject to an attack as the birthday attack regardless of the round function.

As a method that constructs a block cipher having double block length that has a resistance against the birthday attack, Non-Patent Document 2 is known. This literature describes that five- or six-times that repetition of the Feistel type permutation results in resistance against the birthday attack.

However, this result is satisfied in the case in which the round function having n-bit input/output is a pseudorandom function having a theoretical resistance against the birthday attack. Although an n-bit block cipher that is practically safe can be considered as a pseudorandom permutation, as long as an inverse function exists, since the pseudorandom permutation does not become a pseudorandom function having a theoretical resistance against the birthday attack, the above-described result cannot be applied as is.

The pseudorandom permutation can be transformed to the pseudorandom function having a theoretical resistance against the birthday attack by the SUM system disclosed in Non-Patent Document 3, however, whenever one call for the pseudorandom function is performed, at least two calls for the pseudorandom permutation are necessary, thus, when the SUM system is used as the round function in which the Feistel type permutation is repeated five to six times, at least a total of 10 calls to 12 calls for the n-bit block cipher are necessary.

### RELATED ART DOCUMENTS

### Patent Document

### Patent Document 1: JP2002-108205A

### Non-Patent Documents

Non-Patent Document 1: M. Naor, O. Reingold, On the Construction of Pseudo-Random Permutations: Luby-Rackoff Revisited, Electronic Colloquium on Computational Complexity (ECCC) 4(5), 1997.

Non-Patent Document 2: J. Patarin, Security of Random Feistel Schemes with 5 or More Rounds, Advances in Cryptology—CRYPTO 2004, 24th Annual International Cryptology Conference, Santa Barbara, Calif., USA, Aug. 15-19, 2004, Proceedings. Lecture Notes in Computer Science 3152 Springer 2004, pp. 106-122.

Non-Patent Document 3: Lucks, The Sum of PRPs Is a Secure PRF, Advances in Cryptology—EUROCRYPT 2000, International Conference on the Theory and Application of Cryptographic Techniques, Bruges, Belgium, May 14-18, 2000, Proceeding, Lecture Notes in Computer Science 1807 Springer 2000, pp. 470-484.

### SUMMARY OF INVENTION

### Technical Problem

Thus, as methods that construct block ciphers having double block length using a block cipher, only a system that is broken by the birthday attack and a system that has a theoretical resistance but a very bad efficiency have been realized.

The present invention was made from a view point of such a problem and an object of the present invention is to provide encryption devices for a block having double block length that can effectively construct a block cipher having double block length that has a theoretical resistance against a birthday attack using a practical block cipher, a method thereof, a program thereof, decryption devices thereof, a method thereof, and a program thereof.

### Solution to Problem

To accomplish the foregoing object, an encryption device for a block having double block length according to the present invention comprises plaintext input means that inputs a plaintext of 2 n bits to be encrypted; mingling means that permutates said plaintext of 2 n bits based on a universal hash function so as to generate first and second intermediate variables of n bits each; first encryption means for a tweakable unit block that encrypts said first intermediate variable with a tweak that is a result in which said second intermediate variable is shortened to m bits using an encryption function for m-bit tweak n-bit block cipher so as to generate a third intermediate variable of n bits; second encryption means for a tweakable unit block that encrypts said second intermediate variable with a tweak that is a result in which said third intermediate variable is shortened to m bits using said encryption function for m-bit tweak n-bit block cipher so as to generate a fourth intermediate variable of n bits; inversely mingling means that concatenates said third and fourth intermediate variables and inversely mingles the concatenated result based on a universal hash function so as to generate a ciphertext of 2 n bits; and ciphertext output means that outputs said ciphertext of 2 n bits.

A decryption device for a block having double block length according to the present invention comprises ciphertext input means that inputs a ciphertext of 2 n bits to be decrypted; mingling means that permutates said ciphertext of 2 n bits based on a universal hash function so as to generate first and second intermediate variables of n bits each; second decryption means for a tweakable unit block that encrypts said second intermediate variable with a tweak that is a result in which said first intermediate variable is shortened to m bits using a decryption function for m-bit tweak n-bit block cipher so as to generate a third intermediate variable of n bits; first decryption means for a tweakable unit block that encrypts said first intermediate variable with a tweak that is a result in which said third intermediate variable is shortened to m bits using said decryption function for m-bit tweak n-bit block cipher so as to generate a fourth intermediate variable of n bits; inversely mingling means that concatenates said third and fourth intermediate variables and inversely mingles the concatenated result based on a universal hash function so as to generate a plaintext of 2 n bits; and plaintext output means that outputs said plaintext of 2 n bits.

An encryption method for a block having double block length according to the present invention is an encryption method for a block having double block length comprising plaintext input process that inputs a plaintext of 2 n bits to be encrypted; mingling process that permutates said plaintext of 2 n bits based on a universal hash function so as to generate first and second intermediate variables of n bits each; first encryption process for a tweakable unit block that encrypts said first intermediate variable with a tweak that is a result in which said second intermediate variable is shortened to m bits using an encryption function for m-bit tweak n-bit block cipher so as to generate a third intermediate variable of n bits; second encryption process for a tweakable unit block that encrypts said second intermediate variable with a tweak that is a result in which said third intermediate variable is shortened to m bits using said encryption function for m-bit tweak n-bit block cipher so as to generate a fourth intermediate variable of n bits; inversely mingling process that concatenates said third and fourth intermediate variables and inversely mingles the concatenated result based on a universal hash function so as to generate a ciphertext of 2 n bits; and ciphertext output process that outputs said ciphertext of 2 n bits.

A decryption method for a block having double block length according to the present invention is a decryption method for a block having double block length comprising ciphertext input process that inputs a ciphertext of 2 n bits to be decrypted; mingling process that permutates said ciphertext of 2 n bits based on a universal hash function so as to generate first and second intermediate variables of n bits each; second decryption process for a tweakable unit block that encrypts said second intermediate variable with a tweak that is a result in which said first intermediate variable is shortened to m bits using a decryption function for m-bit tweak n-bit block cipher so as to generate a third intermediate variable of n bits; first decryption process for a tweakable unit block that encrypts said first intermediate variable with a tweak that is a result in which said third intermediate variable is shortened to m bits using said decryption function for m-bit tweak n-bit block cipher so as to generate a fourth intermediate variable of n bits; inversely mingling process that concatenates said third and fourth intermediate variables and inversely mingles the concatenated result based on a universal hash function so as to generate a plaintext of 2 n bits; and plaintext output process that outputs said plaintext of 2 n bits.

An encryption program for a block having double block length according to the present invention is an encryption program for a block having double block length that causes a computer to execute the encryption method for a block having double block length according to the present invention.

The decryption program for a block having double block length according to the present invention is a decryption program for a block having double block length that causes a computer to execute the decryption method for a block having double block length according to the present invention.

### ADVANTAGEOUS EFFECTS OF INVENTION

According to the present invention, encryption devices for a block having double block length that can effectively construct a block cipher having double block length that has a theoretical resistance against the birthday attack using a practical block cipher, a method thereof, a program thereof, decryption devices thereof, a method thereof, and a program thereof can be provided.

### BRIEF DESCRIPTION OF DRAWINGS

FIG. 1 is a schematic diagram showing the construction of an encryption device for a block having double block length according to a first embodiment that preferably implements the present invention.

FIG. 2 is a schematic diagram showing a flow of information in the encryption device for a block having double block length according to the first embodiment.

FIG. 3 is a schematic diagram showing principal portions of an encryption device for a block having double block length provided with a mingling section and an inversely mingling section constructed using a Feistel type permutation in the case in which the bit length of a tweak is greater than that of the block size.

FIG. 4 is a schematic diagram showing principal portions of an encryption device for a block having double block length provided with a mingling section and an inversely mingling section constructed using a Feistel type permutation in the case in which the bit length of a tweak is equal to that of the block size.

FIG. 5 is a schematic diagram showing an encryption section for a tweakable unit block realized by using a key update by an ordinary block cipher.

FIG. 6 is a schematic diagram showing a flow of the operation of the encryption device having a double block length according to the first embodiment.

FIG. 7 is a schematic diagram showing the construction of a decryption device for a block having double block length according to a second embodiment that preferably implements the present invention.

FIG. 8 is a schematic diagram showing a flow of information in the decryption device for a block having double block length according to the second embodiment.

FIG. 9 is a schematic diagram showing principal portions of a decryption device for a block having double block length provided with a mingling section and an inversely mingling section constructed using a Feistel type permutation in the case in which the bit length of a tweak is greater than that of the block size.

FIG. 10 is a schematic diagram showing principal portions of a decryption device for a block having double block length provided with a mingling section and an inversely mingling section constructed using a Feistel type permutation in the case in which the bit length of a tweak is equal to that of the block size.

FIG. 11 is a schematic diagram showing a decryption section for a tweakable unit block realized by using a key update by an ordinary block cipher.

FIG. 12 is a schematic diagram showing a flow of the operation of the decryption device for a block having double block length according to the second embodiment.

FIG. 13 is a schematic diagram showing an encryption for a block having double block length realized by repeating the Feistel type permutation four times.

FIG. 14 is a schematic diagram showing a decryption for a block having double block length realized by repeating the Feistel type permutation four times.

### DESCRIPTION OF EMBODIMENTS

The present invention aims at effectively realizing a block cipher having double block length that assures safeness surpassing the birthday bound. Since a tweakable block cipher (a tweak of m bits, a block of n bits) used as a component is theoretically safe and has theoretical safeness in the case in which the number of plaintext and ciphertext pairs that a hacker uses is much smaller than 2(n+m)/2, the block cipher having double block length has a theoretical resistance against the birthday attack.

Although a tweakable block cipher itself is also expected to have safeness surpassing the birthday bound, it can be realized by an ordinary block cipher depending on the length of the tweak (based on the desired safety level), a tweakable block cipher algorithm that was designed from scratch such as Hasty Pudding Cipher described in R. Schroeppel, Specification for the Hasty Pudding Cipher, http://www.cs.arizona.edu/˜rcs/hpc/hpc-spec, is known, and an approach that creates a tweakable block cipher by adding a tweak to an intermediate variable in an ordinary block cipher algorism as described in D. Goldenberg, S. Hohenberger, M. Liskov, E. C. Schwartz, H. Seyalioglu, On Tweaking Luby—Rackoff Blockciphers, Advances in Cryptology—ASIACRYPT 2007, 13th International Conference on the Theory and Application of Cryptology and Information Security, Kuching, Malaysia, Dec. 2-6, 2007, Proceedings, Lecture Notes in Computer Science 4833 Springer 2007, pp. 342-356 (hereinafter referred to as Literature A) has been proposed, thus block ciphers can be realized according to the algorithm on the basis of these outcomes.

In addition, although a process called mingling is necessary at the beginning and the end, this can be realized by a universal hash function and the process can be operated at a much higher speed than the block function by optimization according to the implement environment.

Hereinafter, preferred embodiments of the present invention will be described.

### First Embodiment

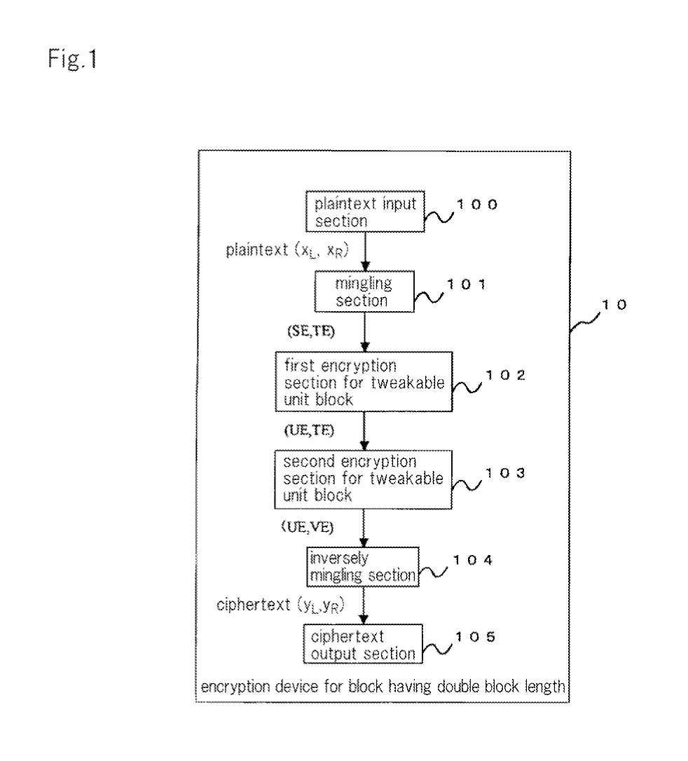

FIG. 1 shows the construction of an encryption device for a block having double block length according to a first embodiment that preferably implements the present invention. Encryption device 10 for a block having double block length has plaintext input section 100, mingling section 101, first encryption section 102 for a tweakable unit block, second encryption section 103 for a tweakable unit block, inversely mingling section 104, and ciphertext output section 105.

Encryption device 10 for a block having double block length can be realized by a

CPU, a memory, and a disk. Each functional section of encryption device 10 for a block having double block length can be realized by a software process in such a manner that the program stored in the disk is caused to be executed in the CPU.

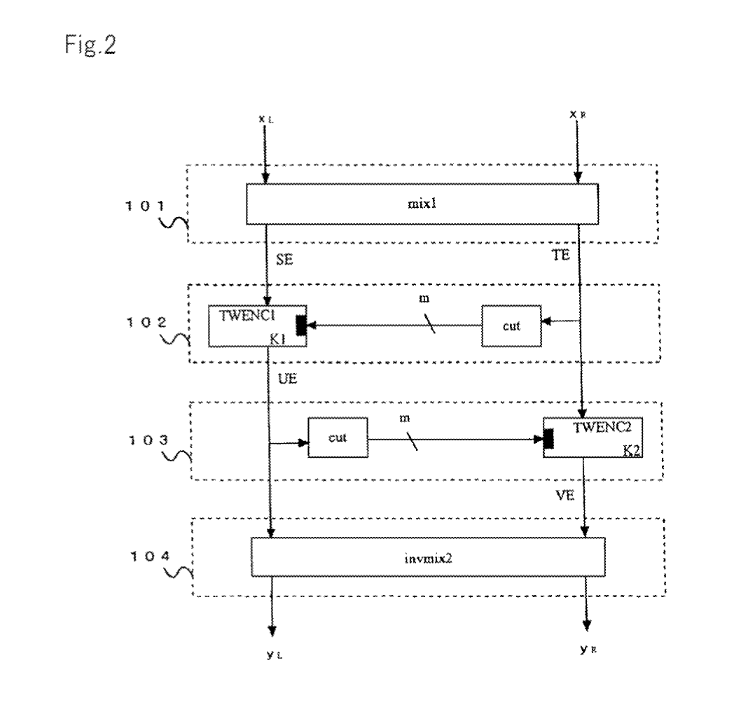

Next, each functional section of encryption device 10 for a block having double block length will be described. In the following description, it is assumed that the block size of a tweakable block cipher is n bits and the length of a tweak is m (1<m<n) bits. FIG. 2 shows a flow of information in mingling section 101, first encryption section 102 for a tweakable unit block, second encryption section 103 for a tweakable unit block, and inversely mingling section 104.

Plaintext input section 100 inputs a plaintext of 2 n bits to be encrypted. This is realized by a character input device such as a keyboard.

Mingling section 101 applies a simple keyed permutation mix1 to the plaintext of 2 n bits that has been input. Assuming that arbitrary different two plaintexts of 2 n bits each x, x′ are denoted by x=(xL, xR), x′=(x′L, x′R) and that the corresponding output of mix1 is denoted by (SE, TE)=mix1(xL, xR) and (SE′, TE′)=mix1(x′L, x′R) (each variable has n bits), any plaintext pair needs to satisfy the conditions of the following formulas (1), (2) with respect to e1, e2 that are sufficiently small regardless of the plaintext.

### [Expression 1]

Pr[SE=SE′⊥cut(TE)=cut(TE′)]≦e1 (1)

Pr[TE=TE′]≦e2 (2)

where cut is a function that extracts arbitrary m bits from an input of n bits. For example, the lowest order m bits can be extracted. On the other hand, the probability is defined by the randomness of a key of mix1. Specifically, mix1 can be realized by a permutation called the pairwise independent permutation in a space of 2 n bits. This means that the input x of 2 n bits is assumed to be an element of a finite field GF(22n) and mul(x, K1)+K2 is output. However, it is assumed that mul(a, b) is the multiplication of elements a, b in GF(22n); K1, K2 are keys of mix1, K1 is equally distributed in a set in which the zero element is excluded from GF(22n), and K2 is equally distributed in the entire GF(22n).

In addition, to alternatively realize mix1, a method using the Feistel type permutation is known. This method can satisfy the following formulas (3) and (4) with a keyed function having n-bit input/output, H, and a keyed function having n-m bit input and n+m bit output, G.

### [Expression 2]

TE=(ZE2+we2)∥we1 (3)

SE=ZE1+xL (4)

where the right-side n-m bits of H(xL)+xR are denoted by we1, the left-side m bits thereof are denoted by we2, the high order n-bits of G(we1) are denoted by ZE1, the low-order m bits thereof are denoted by ZE2, ∥ represents a concatenation of bits, and + represents a bitwise XOR operation.

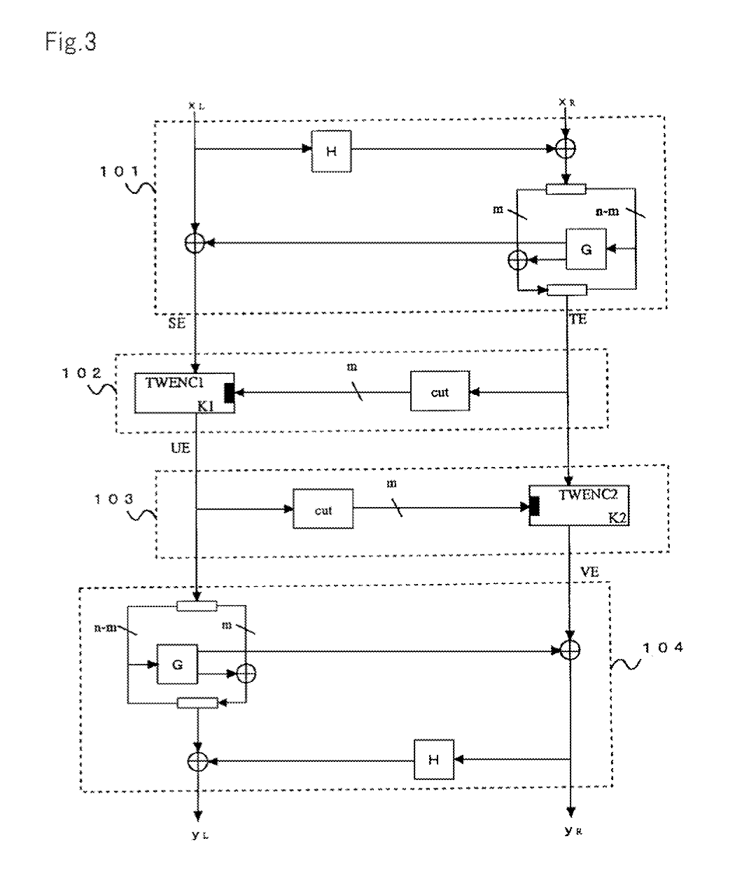

In this case, when the keyed functions H, G are e1-almost universal and e2-almost universal, respectively, the conditions of the formula (1) and the formula (2) can be satisfied. However, when an arbitrary keyed function (having t-bit input and s-bit output) F is e-almost universal, Pr[F(x)=F(x′)] is at most e with respect to a pair of arbitrary different inputs having t bits each, x, x′. A keyed function having such a characteristic is called a universal hash function and can be realized by multiplication in a finite field. Alternatively, a function specialized in a specific implementation environment may be used as described in S. Halevi and H. Krawczyk, MMH: Software Message Authentication in the Gbit/second rates, Fast Software Encryption, 4th International Workshop, FSE '97, Lecture Notes in Computer Science; Vol. 1267, Feb. 1997. A construction that realizes mingling section 101 using the Feistel type permutation in the case of m<n is shown in FIG. 3.

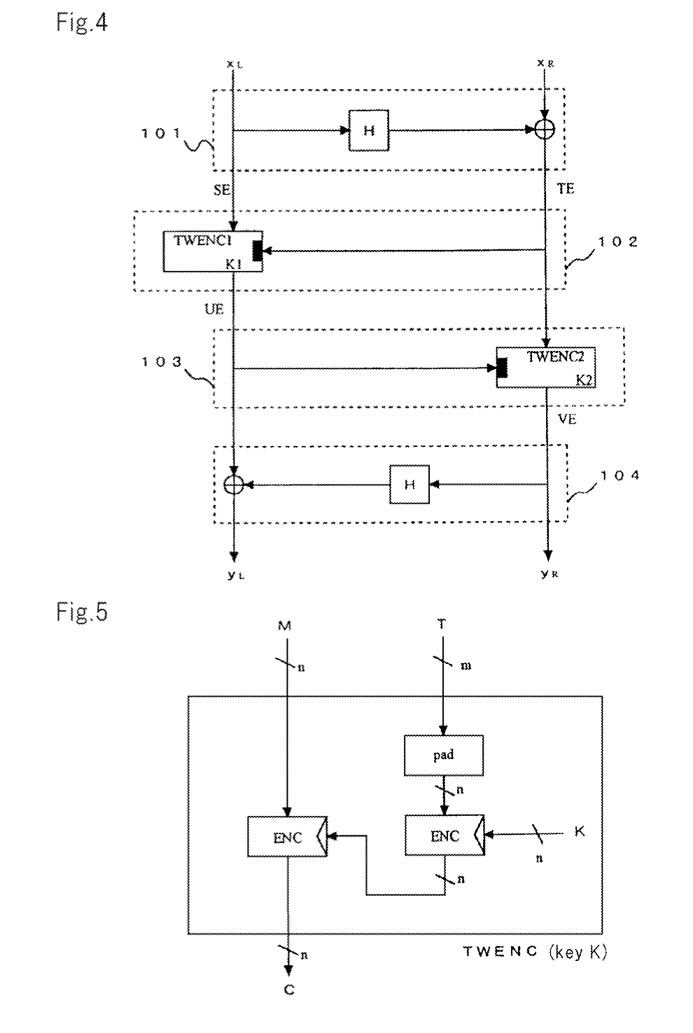

On the other hand, in the case of m=n, since the condition of the formula (1) is not necessary, it becomes sufficient to perform only the process by the function H, not the process by the function G. Specifically, TE=xR+H(xL), SE=xL can be given. The construction applied in this case is shown in FIG. 4.

First encryption section 102 for a tweakable unit block divides the output of mingling section 101 into two blocks of n bits each, uses one of them as a parameter, and encrypts the other.

Specifically, assuming that the output of mingling section 101 is (SE, TE) (n bits each), first encryption section 102 for a tweakable unit block outputs (UE, TE) of 2 n bits each using an encryption function for a tweakable block cipher, TWENC1, as expressed by the following formula (5). In this case, K1 is a key of TWENC1.

### [Expression 3]

UE=TWENC1(K1, cut(TE), SE) (5)

where the tweakable block cipher means a block cipher that performs encryption using a parameter called a tweak besides a secret key. When a tweak and a key are defined, a plaintext and a ciphertext need to correspond to each other. In other words, when an encryption function for a tweakable block cipher, TWENC, and the corresponding decryption function TWDEC exist, the following formula (6) is always satisfied with respect to a plaintext M, a ciphertext C, a key K, and a tweak T.

### [Expression 4]

C=TWENC(K, T, M)⇄M=TWDEC(K, T, C) (6)

The formal definition and safety conditions of a tweakable block cipher including the formula (6) is described in M. Liskov, R. Rivest, D. Wagner, Tweakable Block Ciphers, Advances in Cryptology—CRYPTO 2002, 22nd Annual International Cryptology Conference, Santa Barbara, Calif., USA, Aug. 18-22, 2002, Proceedings, Lecture Notes in. Computer Science 2442 Springer 2002, pp. 31-46 (hereinafter referred to as Literature B).

A tweakable block cipher used in first encryption section 102 for a tweakable unit block has a tweak of m bits as expressed by the formula (5) and has a block size of n bits.

To specifically construct a tweakable block cipher, a method that adds a tweak to a part of an intermediate variable for an existing block cipher or its serial synthesis is known. For example, the validity of such an approach about a Feistel cipher is described in Literature A.

Alternatively, using key updating of a block cipher that depends on a tweak, a tweakable block cipher can be constructed without need to modify an existing algorithm of an n-bit block cipher (that is non-tweakable). Specifically, an encryption function for block cipher having n-bit block and n-bit key, ENC, is used. TWENC1 that encrypts the plaintext M with the tweak T (m bits) and the key K1 is defined by the following formula (7).

### [Expression 5]

TWENC1(K1, T, M)=ENC(V, M), V=ENC(K1, pad(T)) (7)

where K is a key having n bits of a block cipher; pad is an appropriate padding of n-m bits (for example, all zeros are added). TWENC applied in this case is shown in FIG. 5.

In the case that this TWENC is used, the process of the foregoing formula (5) is expressed by the following formula (8).

### [Expression 6]

UE=TWENC1(K1, cut(TE), SE)=ENC(V, SE), V=ENC(K1, pad(cut(TE))) (8)

where pad(cut(TE)) may be a process that simply fixes arbitrary n-m bits of TE. However, this system needs to satisfy the relationship of m<n/2 due to safety reasons.

Although the system described in Literature B and the XEX mode described in P. Rogaway: Efficient Instantiations of Tweakable Blockciphers and Refinements to Modes OCB and PMAC, Advances in Cryptology—ASIACRYPT 2004, 10th International Conference on the Theory and Application of Cryptology and Information Security, Jeju Island, Korea, Dec. 5-9, 2004, Proceedings, Lecture Notes in Computer Science 3329 Springer 2004, pp. 16-31, and so forth can realize a tweakable block cipher using an n-bit block cipher, their safeness does not surpass that of the birthday bound.

Second encryption section 103 for a tweakable unit block divides 2 n bits that first encryption section 102 for a tweakable unit block outputs into two blocks of n bits each, uses one of them as a parameter, and encrypts the other. Specifically, assuming that the output of first encryption section 102 for a tweakable unit block is (UE, TE) (n bits each), second encryption section 103 for a tweakable unit block outputs (UE, VE) of 2 n bits each using an encryption function for a tweakable block cipher, TWENC2, (a tweak of m bits, a block of n bits) as expressed by the following formula (9). In this case, K2 is a key of TWENC2.

### [Expression 7]

VE=TWENC2(K2, cut(UE), TE) (9)

Like TWENC1, TWENC2 may be generated as the following formula (10) using an encryption function for a block cipher having n-bit block n-bit key, ENC, according to FIG. 5. In this case, however, like TWENC1, this system needs to satisfy the relationship of m<n/2 due to safety reasons.

### [Expression 8]

VE=TWENC2(K2, cut(UE), TE)=ENC(V, TE), V=ENC(K2, pad(cut(UE))) (10)

The encryption function TWENC2 may be an algorithm that is different from or the same as TWENC1 that first encryption section 102 for a tweakable unit block uses. In the latter case, the relationship of TWENC2(K, T, M)=TWENC1(K, T, M) needs to be satisfied with respect to arbitrary M, K, and T. In addition, K2 may be the same as or independent from the key K1 that first encryption section 102 for a tweakable unit block uses.

Inversely mingling section 104 applies a simple tweakable permutation invmix2 to the output of 2 n bits of second encryption section 103 for a tweakable unit block. Assuming that the input of inversely mingling section 104 is (UE, VE), the output is denoted by invmix2(UE, VE). It is assumed that when the inverse permutation of invmix12 is denoted by mix2 (namely, mix2 with respect to x of arbitrary 2 n bits (invmix2(x)=x)), mix2 has the same characteristics as mix1 of mingling section 101.

Specifically, assuming that two different arbitrary ciphertexts of 2 n bits each, y, y′, are denoted by y=(yL, yR), y′=(y′L, y′R) and that the corresponding output of mix2 is denoted by (UE, VE)=mix2(yL, yR) and (UE′, VE′)=mix2(y′L, y′R) (each variable has n bits), any ciphertext pair needs to satisfy the conditions of the following formulas (11), (12) with respect to g1, g2 that are sufficiently small.

### [Expression 9]

Pr[VE=VE′⊥cut(UE)=cut(UE′)]≦g1 (11)

Pr[UE=UE′]≦g2 (12)

where mix2 may be generated by mirror-inverting the process of mix1; when mix2 is defined, invmix2 is uniquely obtained.

Specifically, invmix2 is an inverse permutation of the pairwise independent permutation of mix1 or when mix1 is a Feistel type permutation, if the input of invmix2 is (UE, VE) and the output thereof is (yL, yR), the following formulas (13), (14) need to be satisfied.

### [Expression 10]

yR=VE+ZE3 (13)

yL=H(yR)+(we3∥(ZE4+we4)) (14)

where the left-side n-m bits of UE is denoted by we3, the right-side m-bits thereof is denoted by we4, the high-order n-bits of G(we3) is denoted by ZE3, and the low-order m bits thereof is denoted by ZE4. The keys of the keyed functions H and G used in this case may be the same as or independent from those of H and G that mingling section 101 uses. The composition of which inversely mingling section 104 is realized using the Feistel type permutation in the case of m<n is shown in FIG. 3.

On the other hand, in the case of m=n, since the condition of the foregoing formula (11) is not necessary, (yL, yR) can be simply output as yR=VE, yL=H(yR)+UE. The construction applied in this case is shown in FIG. 4.

Ciphertext output section 105 outputs a ciphertext (yL, yR) that is input from inversely mingling section 104. Ciphertext output section 105 can be realized by a computer display, a printer, or the like.

Specifically, in the case in which a communication or data storage is encrypted, it can be contemplated that a 2 n-bit block cipher obtained in this embodiment can be used in any cipher mode. In other words, information such as packets to be encrypted is divided every 2 n bits and in the case of a communication, the CBC mode or the OCB mode described in T. Krovetz and P. Rogaway, The OCB Authenticated—Encryption Algorithm, Internet draft, March 2005 is applied. When data storage such as a hard disk is encrypted, the system described in Literature B can be applied. In this case, while a mask value is added corresponding to a sector of the hard disk and the byte position in the sector (one sector is normally composed of 512 bytes), the ECB mode encryption is performed.

In this method, assuming that for example n=128 and that an encryption function for 256-bit-block cipher obtained in this embodiment is denoted by DENC, the contents of each sectors are divided every 256 bits (32 bytes). It is assumed that the divided result is denoted by (m1, m2, . . . , m16) where mi is composed of 32 bytes. At this point, mi (i=1, . . . , 16) is encrypted as DENC(mi+mul(i, SecNum)). In this case, SecNum is a random number corresponding to a sector number (generated by encrypting a sector number with a block cipher) and mul(i, SecNum) represents a multiplication in the case in which i and SecNum are elements of a finite field GF(2256).

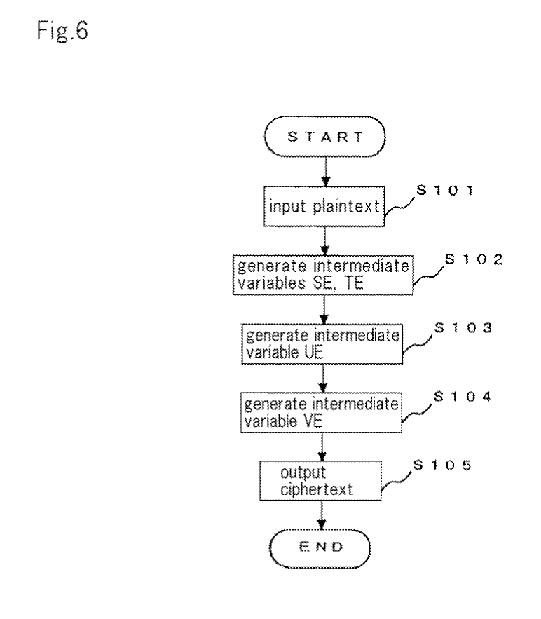

FIG. 6 shows a flow of the operation of the encryption device for a block having double block length according to this embodiment.

First, a plaintext (xL, xR) is input through plaintext input section 100 (at step S101) and mingling section 101 is caused to obtain intermediate variables (SE, TE) (at step S102). Thereafter, first encryption section 102 for a tweakable unit block is caused to encrypt SE with a tweak that is an arbitrary m bit portion of UE according to the foregoing formula (5) so as to obtain UE (at step S103). Thereafter, second encryption section 103 for a tweakable unit block is caused to encrypt TE with a tweak that is an arbitrary m bit portion of UE so as to obtain VE (at step S104). Thereafter, the obtained (UE, VE) are input to inversely mingling section 104 and then a ciphertext (yL, yR) is output (at step S105).

### Second Embodiment

A second embodiment that preferably implements the present invention will be described.

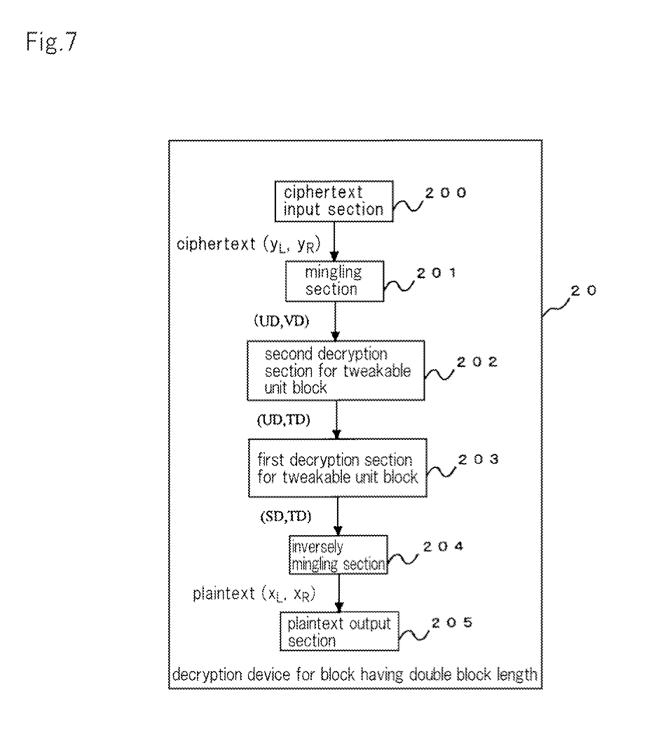

FIG. 7 shows the construction of a decryption device for a block having double block length according to this embodiment. Decryption device 20 for a block having double block length has ciphertext input section 200, mingling section 201, second decryption section 202 for a tweakable unit block, first decryption section 203 for a tweakable unit block, inversely mingling section 204, and plaintext output section 205.

Decryption device 20 for a block having double block length can be realized by a CPU, a memory, and a disk. Each functional section of decryption device 20 for a block having double block length can be realized by a software process in such a manner that the program stored in the disk is caused to be executed in the CPU.

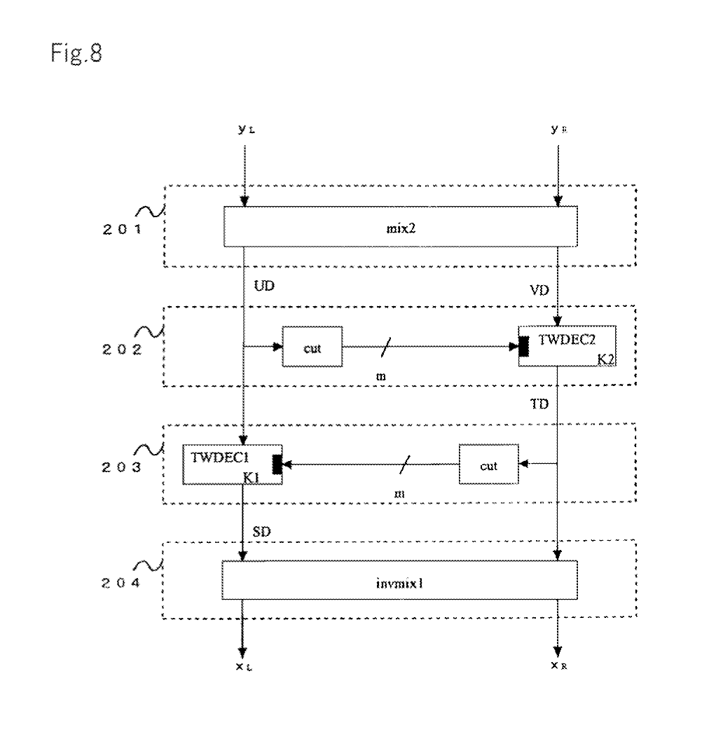

Each functional section of decryption device 20 for a block having double block length will be described. In the following description, it is assumed that the block size of a tweakable block cipher is n bits and the length of the tweak is m(1<m<n) bits. FIG. 8 shows a flow of information in mingling section 201, second decryption section 202 for a tweakable unit block, first decryption section 203 for a tweakable unit block, and inversely mingling section 104.

Ciphertext input section 200 inputs a ciphertext of 2 n bits to be decrypted. This can be realized by a character input device such as a keyboard.

Mingling section 201 applies a keyed permutation mix2 to the ciphertext of 2 n bits that has been input. mix2 is an inverse permutation of the permutation invmix2 of 2 n bits that inversely mingling section 104 according to the first embodiment uses. Specifically, for example, invmix2 is specified by the formula (13) and the formula (14). In the case of the Feistel type permutation using the keyed functions H and G, mix2 can obtain the following formulas (15), (16) with respect to the input ciphertext (yL, yR) and then output (UD, VD).

### [Expression 11]

UD=wd1∥(ZD2+wd2) (15)

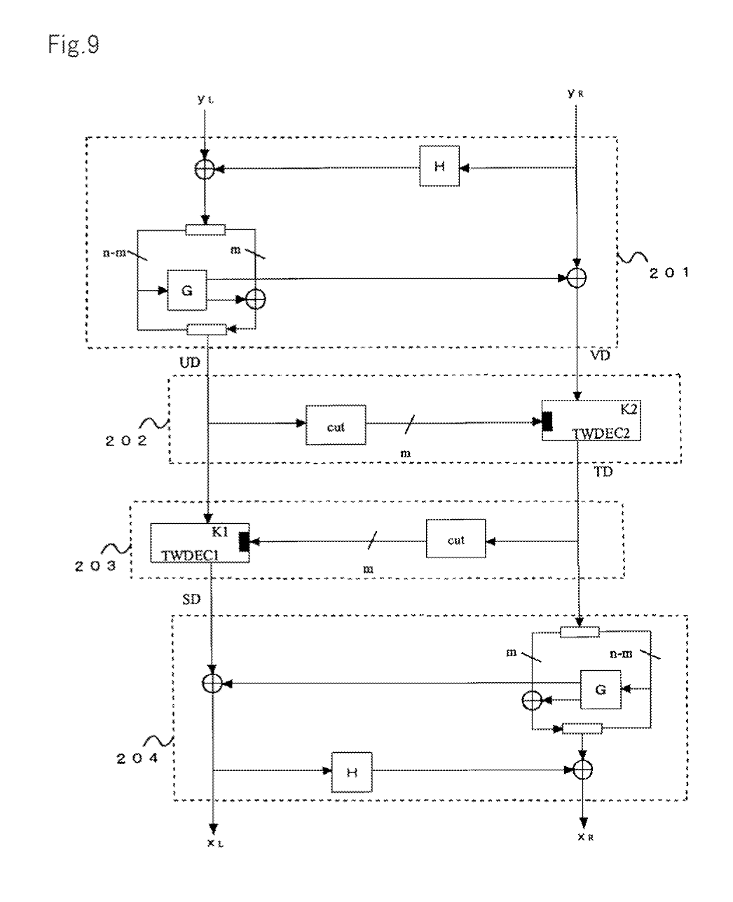

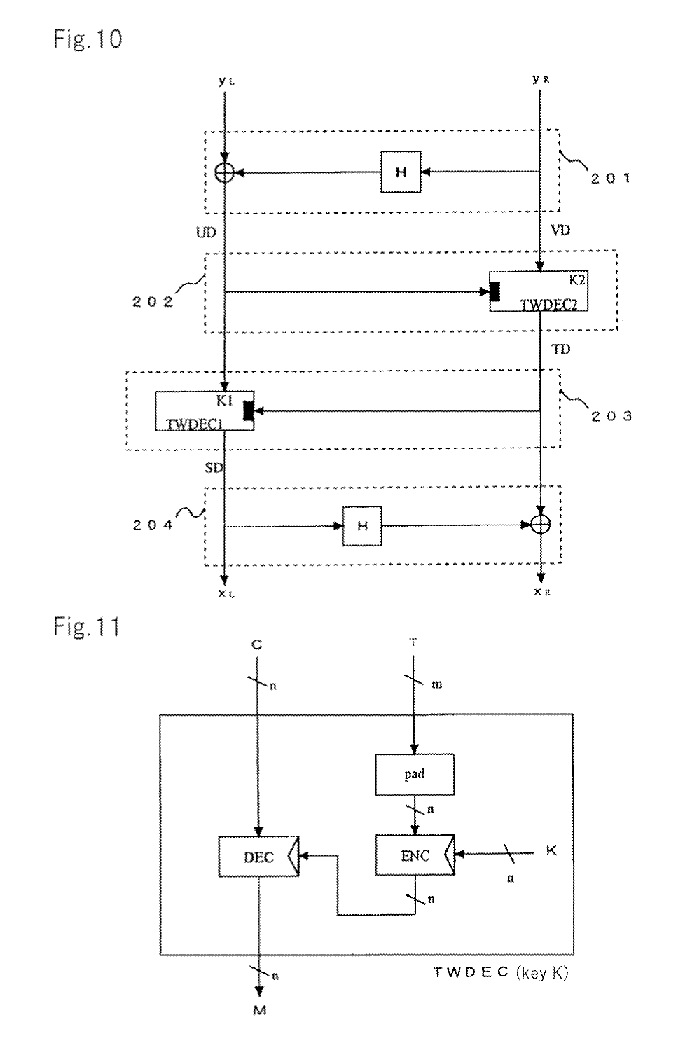

VD=ZD1+yR (16)

where the left-side n-m bits of H(yR)+yL is denoted by wd1, the right-side m bits thereof is denoted by wd2, the high-order n bits of G(wd1) is denoted by ZD1, and the low-order m bits thereof is denoted by ZD2. The construction in which mingling section 201 is realized using the Feistel type permutation in the case of m<n is shown in FIG. 9. In the case of m=n, (UD, VD) can be simply output as VD=yR, UD=yL+H(yR). The construction applied in this case is shown in FIG. 10.

Second decryption section 202 for a tweakable unit block divides the output of mingling section 201 into two blocks of n bits each, uses one of them as a parameter, and encrypts the other. Specifically, assuming that the output of mingling section 201 is (UD, VD) (n bits each), second decryption section 202 for a tweakable unit block obtains TD from (UD, VD) using a decryption function TDEC2 corresponding to the encryption function for tweakable block cipher TWENC2 that second encryption section 103 for a tweakable unit block of the first embodiment uses according to the following formula (17) and then outputs (UD, TD). A key K2 of TWDEC2 has the same value as K2 of the foregoing formula (9).

### [Expression 12]

TD=TWDEC2(K2, cut(UD), VD) (17)

In the case in which TWENC2 is performed with the encryption function for n-bit block cipher, ENC, according to the foregoing formula (10), TWDEC2 can be realized using the encryption function for n-bit block, n-bit key block cipher, ENC, and the decryption function for n-bit block, n-bit key block cipher, DEC. Specifically, with respect to the key K of n bits, the ciphertext C of n bits, and the tweak T of m bits, TWENC2 is defined as the following formula (18). TWDEC corresponding to TWENC2 is shown in FIG. 11.

### [Expression 13]

TWDEC2(K, T, C)=DEC(V, C), V=ENC(K, pad (T)) (18)

The process of the foregoing formula (17) in the case in which the TWDEC2 is used is expressed by the following formula (19).

### [Expression 14]

TD=TWDEC2(K2, cut (UD, VD))=DEC(V, VD), V=ENC(K2, pad(cut (UD))) (19)

where pad(cut (UD)) may be a process that simply fixes arbitrary n-m bits of UD. However, like in the case of TWENC, this system needs to satisfy the relationship of m<n/2 due to safety reasons.

First decryption section 203 for a tweakable unit block divides 2 n bits in which second decryption section 202 for a tweakable unit block outputs into two blocks of n bits each, uses one of them as a parameter, and decrypts the other.

Specifically, in the case in which the output of second decryption section 202 for a tweakable unit block is denoted by (UD, TD) (n bits each), first decryption section 203 for a tweakable unit block outputs (SD, TD) of 2 n bits each from (UD, TD) using a decryption function TWDEC1 corresponding to the encryption function for tweakable block cipher TWENC1 (a tweak of m bits, a block of n bits) that first encryption section 102 for a tweakable unit block of the first embodiment uses according to the following formula (20). A key K1 of TWDEC1 has the same value as K1 of the foregoing formula (5).

### [Expression 15]

SD=TWDEC(K1, cut(TD), UD) (20)

If TWENC1 is performed using the encryption function for n-bit block cipher ENC, like in the case of TWDEC2, TWDEC1 can be expressed using the encryption function for n-bit block cipher, ENC, and the decryption function for n-bit block cipher, DEC, as the following formula (21).

### [Expression 16]

SD=TWDEC1(K1, cut(TD), UD)=DEC(V, UD), V=ENC(K1, pad(cut(TD))) (21)

The decryption function TWDEC1 may be an algorithm that is different from or that is the same as TWDEC2 that second decryption section 201 for a tweakable unit block uses. In the latter case, the relationship of TWDEC1(K, T, C)=TWDEC2(K, T, C) is satisfied with respect to arbitrary C, K, and T. In addition, K1 may be the same as or different from the key K2 that second decryption section 202 for a tweakable unit block uses.

Inversely mingling section 204 applies a keyed permutation invmix1 to the output of first decryption section 203 for a tweakable unit block. Invmix1 is an inverse permutation of the permutation mix1 that mingling section 101 according to the first embodiment uses.

Plaintext output section 205 outputs a plaintext (xL, xR) supplied from inversely mingling section 204. Plaintext output section 205 can be realized by a computer display, a printer, or the like.

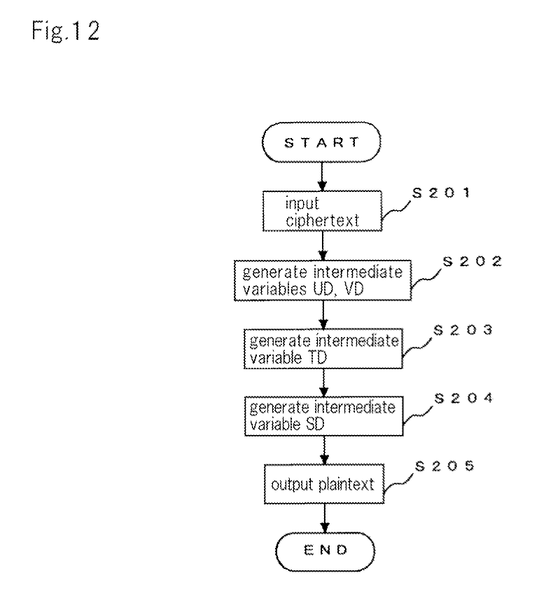

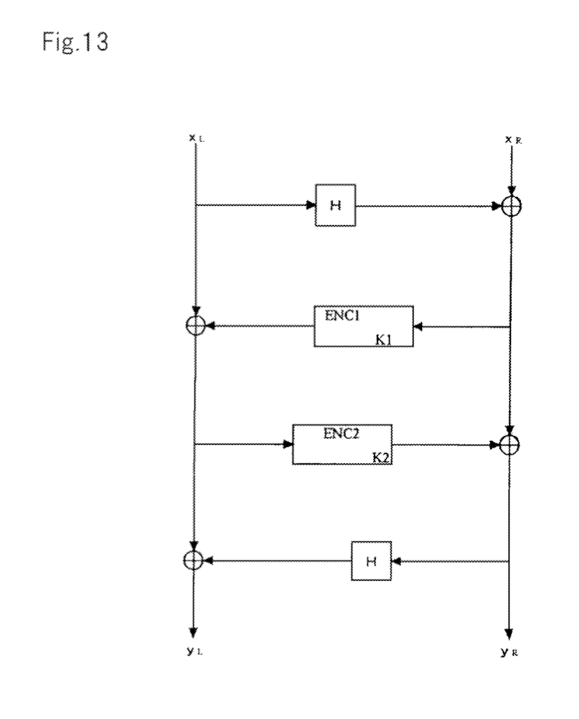

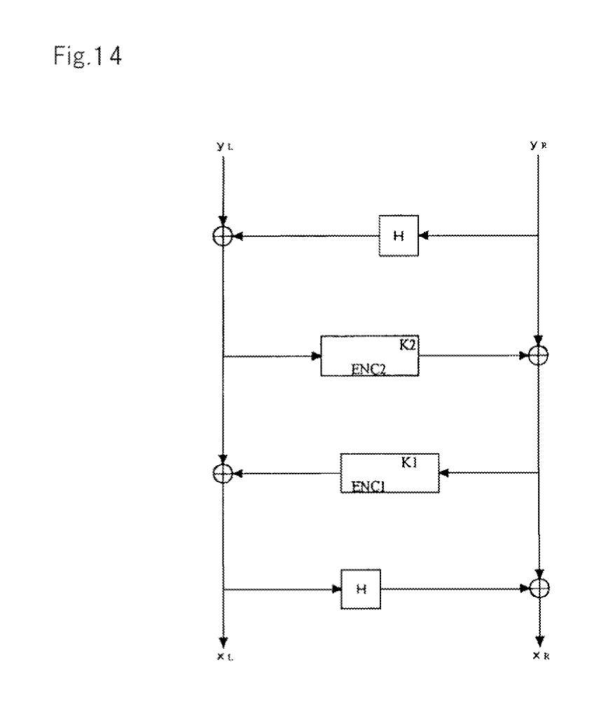

FIG. 12 shows a flow of the operation of decryption device 20 for a block having double block length according to this embodiment.

First, an ciphertext (yL, yR) is input through ciphertext input section 200 (at step S201) and mingling section 201 is caused to obtain intermediate variables (UD, VD) (at step S202). Thereafter, second decryption section 202 for a tweakable unit block is caused to decrypt VD with a tweak that is an arbitrary m bit portion of UD according to the foregoing formula (17) so as to obtain TD (at step S203). Thereafter, first decryption section 203 for a tweakable unit block is caused to decrypt UD with a tweak that is an arbitrary m bit portion of TD so as to obtain SD (at step S204). Thereafter, the obtained (SD, TD) are input to inversely mingling section 204 and then a plaintext (xL, xR) is output (at step S205).

The foregoing individual embodiments are examples of preferred implementations of the present invention and therefore the present invention is not limited thereto.

For example, the present invention can be applied to authentication and encryption for wireless or wired data communication and encryption and forgery prevention for data stored in a storage.

Thus, the present invention can be variously modified.

This application is based upon and claims the benefit of priority from Japanese Patent Application No. 2008-221631 filed on Aug. 29, 2008, the content of which is incorporated by reference.

### REFERENCE SIGNS LIST

10 Encryption device for a block having double block length

20 Decryption device for a block having double block length

100 Plaintext input section

101, 201 Mingling section

102 First encryption section for a tweakable unit block

103 Second encryption section for a tweakable unit block

104, 204 Inversely mingling section

105 Ciphertext output section

200 Ciphertext input section

202 Second decryption section for a tweakable unit block

203 First decryption section for a tweakable unit block

205 Plaintext output section

1-12. (canceled)

13. An encryption device for a block having double block length, comprising:
plaintext input section that inputs a plaintext of 2 n bits to be encrypted;
mingling section that permutates said plaintext of 2 n bits based on a universal hash function so as to generate first and second intermediate variables of n bits each;
first encryption section for a tweakable unit block that encrypts said first intermediate variable with a tweak that is a result in which said second intermediate variable is shortened to m bits using an encryption function for m-bit tweak n-bit block cipher so as to generate a third intermediate variable of n bits;
second encryption section for a tweakable unit block that encrypts said second intermediate variable with a tweak that is a result in which said third intermediate variable is shortened to m bits using said encryption function for m-bit tweak n-bit block cipher so as to generate a fourth intermediate variable of n bits;
inversely mingling section that concatenates said third and fourth intermediate variables and inversely mingles the concatenated result based on a universal hash function so as to generate a ciphertext of 2 n bits; and
ciphertext output section that outputs said ciphertext of 2 n bits.

14. The encryption device for a block having double block length according to claim 13, wherein said universal hash function based permutation and said universal hash function based inverse permutation are realized by performing a Feistel type permutation in which a universal hash function is a round function, for one time when m=n or for two times when m<n.

15. The encryption device for a block having double block length according to claim 13,
wherein said encryption function is an encryption function that causes a block length of a plaintext to be n bits and a key length to be n bits,
wherein said first encryption section for a tweakable unit block encrypts a value of said tweak that is caused to become n bits by padding as a plaintext with a key of n bits using said encryption function and encrypts said first intermediate variable as a plaintext with a key of n bits that is said encrypted result so as to generate said third intermediate variable, and
wherein said second encryption section for a tweakable unit block encrypts a value of said tweak that is caused to become n bits by padding as a plaintext with a key of n bits using said encryption function and encrypts said third intermediate variable as a plaintext with a key of n bits that is said encrypted result so as to generate said fourth intermediate variable.

16. The encryption device for a block having double block length according to claim 13,
wherein the encryption function for m-bit tweak n-bit block cipher that said first and second encryption section for a tweakable unit block use is a function that adds a tweak to an intermediate variable in an encryption process for n-bit block cipher so as to perform a tweakable encryption.

17. A decryption device for a block having double block length, comprising:
ciphertext input section that inputs a ciphertext of 2 n bits to be decrypted;
mingling section that permutates said ciphertext of 2 n bits based on a universal hash function so as to generate first and second intermediate variables of n bits each;
second decryption section for a tweakable unit block that decrypts said second intermediate variable with a tweak that is a result in which said first intermediate variable is shortened to m bits using a decryption function for m-bit tweak n-bit block cipher so as to generate a third intermediate variable of n bits;
first decryption section for a tweakable unit block that decrypts said first intermediate variable with a tweak that is a result in which said third intermediate variable is shortened to m bits using said decryption function for m-bit tweak n-bit block cipher so as to generate a fourth intermediate variable of n bits;
inversely mingling section that concatenates said third and fourth intermediate variables and inversely mingles the concatenated result based on a universal hash function so as to generate a plaintext of 2 n bits; and
plaintext output section that outputs said plaintext of 2 n bits.

18. The decryption device for a block having double block length according to claim 17, wherein the universal hash function based permutation and the universal hash function based inverse permutation are realized by performing a Feistel type permutation of which a universal hash function is a round function, for one time when m=n or for two times when m<n.

19. The decryption device for a block having double block length according to claim 17,
wherein said decryption function is a decryption function that causes a block length of a ciphertext to be n bits and a key length to be n bits,
wherein said first decryption section for a tweakable unit block decrypts a value of said tweak that is caused to become n bits by padding as a ciphertext with a key of n bits using said decryption function and decrypts said first intermediate variable as a ciphertext with a key of n bits that is said decrypted result so as to generate said third intermediate variable, and
wherein said second decryption section for a tweakable unit block decrypts a value of said tweak that is caused to become n bits by padding as a ciphertext with a key of n bits using said decryption function and decrypts said first intermediate variable as a ciphertext with a key of n bits that is said decrypted result so as to generate said fourth intermediate variable.

20. The decryption device for a block having double block length according to claim 17,
wherein the decryption function for m-bit tweak n-bit block cipher that said first and second decryption section for a tweakable unit block use is a function that adds a tweak to an intermediate variable in a decryption process for n-bit block cipher E so as to perform a tweakable decryption.

21. An encryption method for a block having double block length, comprising:
plaintext input process that inputs a plaintext of 2 n bits to be encrypted;
mingling process that permutates said plaintext of 2 n bits based on a universal hash function so as to generate first and second intermediate variables of n bits each;
first encryption process for a tweakable unit block that encrypts said first intermediate variable with a tweak that is a result in which said second intermediate variable is shortened to m bits using an encryption function for m-bit tweak n-bit block cipher so as to generate a third intermediate variable of n bits;
second encryption process for a tweakable unit block that encrypts said second intermediate variable with a tweak that is a result in which said third intermediate variable is shortened to m bits using said encryption function for m-bit tweak n-bit block cipher so as to generate a fourth intermediate variable of n bits;
inversely mingling process that concatenates said third and fourth intermediate variables and inversely mingles the concatenated result based on a universal hash function so as to generate a ciphertext of 2 n bits; and
ciphertext output process that outputs said ciphertext of 2 n bits.

22. A decryption method for a block having double block length, comprising:
ciphertext input process that inputs a ciphertext of 2 n bits to be decrypted;
mingling process that permutates said ciphertext of 2 n bits based on a universal hash function so as to generate first and second intermediate variables of n bits each;
second decryption process for a tweakable unit block that decrypts said second intermediate variable with a tweak that is a result in which said first intermediate variable is shortened to m bits using a decryption function for m-bit tweak n-bit block cipher so as to generate a third intermediate variable of n bits;
first decryption process for a tweakable unit block that decrypts said first intermediate variable with a tweak that is a result in which said third intermediate variable is shortened to m bits using said decryption function for m-bit tweak n-bit block cipher so as to generate a fourth intermediate variable of n bits;
inversely mingling process that concatenates said third and fourth intermediate variables and inversely mingles the concatenated result based on a universal hash function so as to generate a plaintext of 2 n bits; and
plaintext output process that outputs said plaintext of 2 n bits.

23. An encryption program product for a block having double block length that causes a computer to execute the encryption method for a block having double block length according to claim 21.

24. A decryption program product for a block having double block length that causes a computer to execute the decryption method for a block having double block length according to claim 22.
